(19) United States
(12) Patent Application Publication
(10) Pub. No.: US 2026/0371451 A1
(43) Pub. Date: Nov. 19, 2026

(54) FLOW HEATER

(71) Applicant: BorgWarner Inc., Auburn Hills, MI (US)

(72) Inventors: Shu Liu, Ningbo (CN); Zhanhua Mo, Ningbo (CN); Qijian Luo, Ningbo (CN)

(21) Appl. No.: 19/672,191

(22) Filed: May 8, 2026

(30) Foreign Application Priority Data
May 19, 2025 (EP) 25 177 319.8

(51) Int. Cl. H05B 3/82; H05B 3/44

(52) U.S. Cl. CPC H05B 3/82; H05B 3/44; H05B 2203/016; H05B 2203/021

(57) ABSTRACT

Disclosed is a flow heater having a housing with a channel for liquid to be heated extending from an inlet to an outlet. A tubular heating element is arranged in the channel. The tubular heating element includes a tubular sheath, resistive wire, and isolating material electrically isolating the resistive wire from the tubular sheath. The channel is defined by a meandering groove in a first housing part. The tubular heating element has a meandering shape and is arranged in the groove.

### RELATED APPLICATIONS

This application claims priority to European Patent Application No. 25 177 319.8, filed May. 19, 2025, the entire disclosure of which is hereby incorporated herein by reference.

### BACKGROUND AND SUMMARY

This disclosure refers to a flow heater for heating liquids generally of the type disclosed in German Patent Application No. 11 2013 002 131 T5.

Flow heaters are used in vehicles, especially in electric or hybrid cars, to heat liquids, especially aqueous solutions. A constant goal in the design of such flow heaters is to provide a compact and cost-efficient flow heater. This disclosure teaches a more compact and cost-efficient flow heater.

In a flow heater according to this disclosure, the channel for liquid to be heated is defined by a meandering groove in a housing part. The tubular heating element has a matching meandering shape and is arranged in the groove. The meandering shape of the groove enables a long channel wherein liquid to heated flows along the tubular heating element. Thus, a compact flow heater with advantageous heating characteristics can be provided.

In a refinement of this disclosure, the groove is closed by a second housing part that has an opening through which all ends of the tubular heating elements protrude. The electrical connections to the tubular heating elements can thereby be arranged on a dry side of the second housing element and thus separated from liquid to be heated. In an advantageous refinement, this opening is closed by a metal plate that is penetrated by each end of the tubular heating element. The tubular heating element can be brazed or welded to the metal plate to establish a fluid tight connection. In a further refinement, the metal plate forms a collar around each opening that is penetrated by an end of the tubular heating element. Such a collar facilitates a tight connection between metal plate and tubular heating element.

In a further refinement of this disclosure, the channel branches in an initial section into a first subchannel and a second subchannel, wherein the first subchannel and the second subchannel merge into an end section of the channel. For example, the channel may branch into the first subchannel and the second subchannel at a bend of the tubular heating element, e.g., a bend of 180°, and the first subchannel and the second subchannel may merge at another bend of the tubular heating element. In this way a compact, flat flow heater can be realized.

### BRIEF DESCRIPION OF THE DRAWINGS

The above-mentioned aspects of exemplary embodiments will become more apparent and will be better understood by reference to the following description of the embodiments taken in conjunction with the accompanying drawings, wherein:

FIG. 1 shows a flow heater in a perspective view;

FIG. 2 shows another perspective view of the flow heater;

FIG. 3 shows a first housing part of the flow heater;

FIG. 4 shows a sectional view of the flow heater;

FIG. 5 shows tubular heaters of the flow heater;

FIG. 6 shows a wet side of a second housing part;

FIG. 7 shows a dry side of the second housing part shown in FIG. 5;

FIG. 8 shows the second housing part with attached tubular heaters;

FIG. 9 shows the dry side of the second housing part with attached tubular heaters;

FIG. 10 shows the second housing part with an attached circuit board; and

FIG. 11 shows a detail of a cross-section of the flow heater.

### DESCRIPTION

The embodiments described below are not intended to be exhaustive or to limit the invention to the precise forms disclosed in the following description. Rather, the embodiments are chosen and described so that others skilled in the art may appreciate and understand the principles and practices of this disclosure.

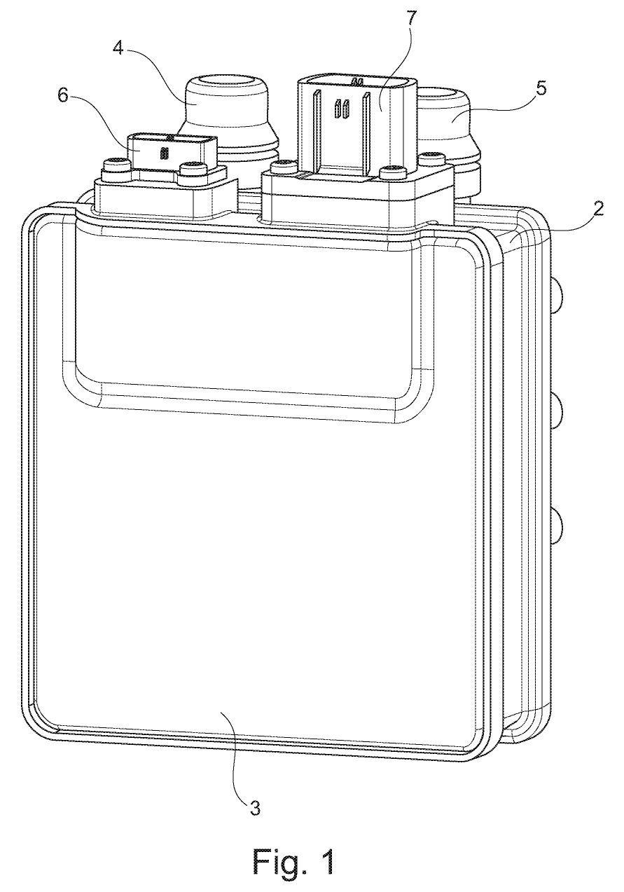

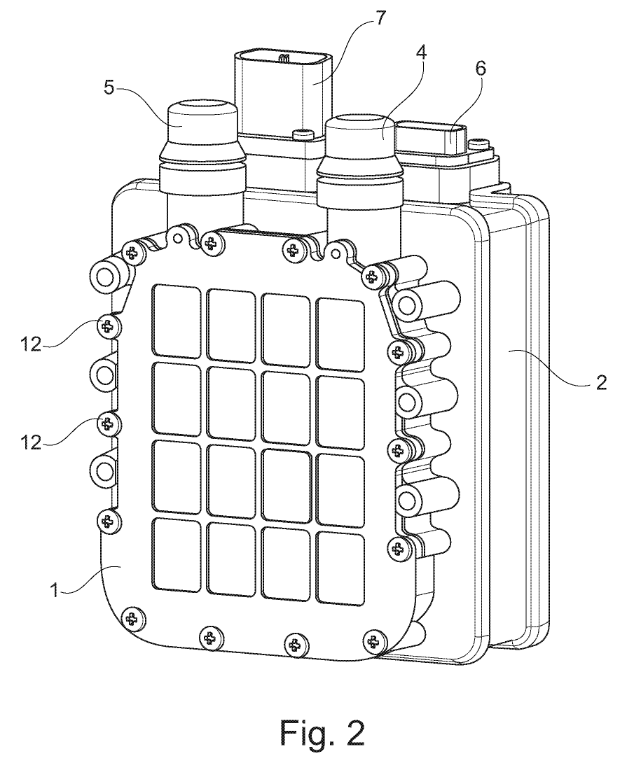

FIGS. 1 and 2 show a front side and back side of a flow heater, respectively. The flow heater shown is a flow heater for heating liquid, e.g., water, in an electric vehicle. The flow heater has a housing comprising a first housing part 1, a second housing part 2 and a third housing part 3. The flow heater has an inlet 4 and an outlet 5 that are arranged at the second housing part 2, but may also be provided at, e.g., the first housing part. The flow heater also has electrical plug connectors 6, 7. In the embodiment shown, the electrical connectors 6, 7 are provided at the second housing part 2, but may also be provided at a different housing part, e.g., the third housing part 3.

In the embodiment shown, connector 7 is for connecting a heating element of the flow heater to a voltage source, e.g., a high voltage source, and connector 8 is for connecting control electronics of the flow heater to a control unit of a vehicle.

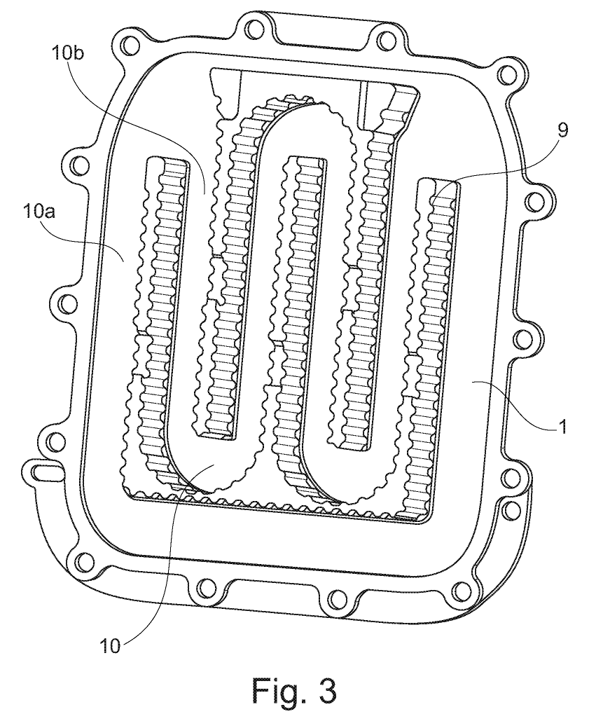

FIG. 3 shows the first housing part 1 of the flow heater. The first housing part 1 comprises internal walls that define a meandering groove and thereby a channel 10 for liquid to heated that extend form the inlet 4 to the outlet 5. These internal walls are side walls 9 of the groove and may be corrugated to improve flow characteristics of liquid to be heated inside the channel 10.

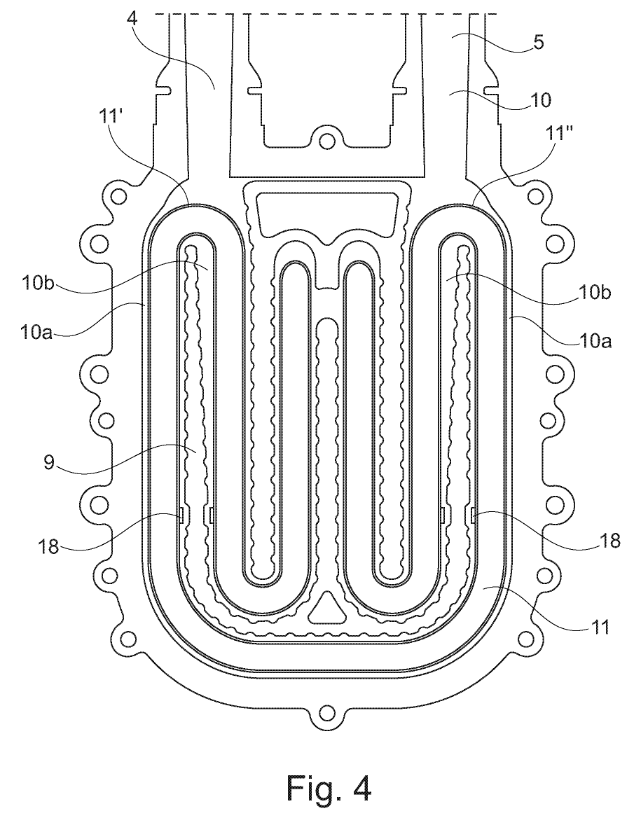

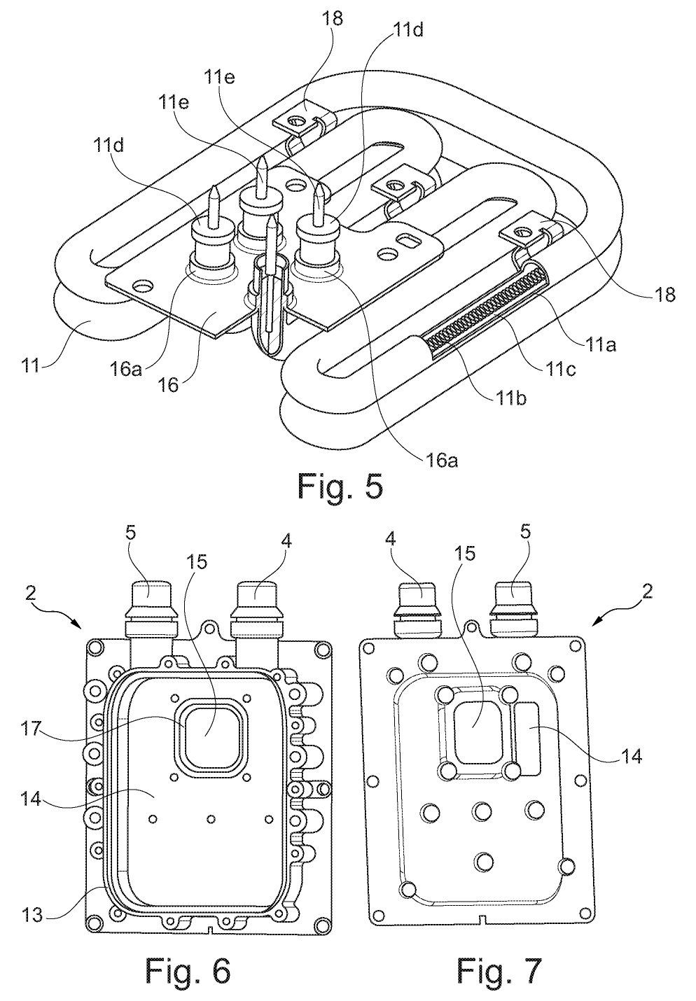

FIG. 4 shows schematically a sectional view of the flow heater. As can be seen therein, a tubular heating element 11 also shown in FIG. 5 is arranged in the groove. The channel 10 branches in an initial section into a first subchannel 10a and a second subchannel 10b. The first subchannel 10a and the second subchannel 10b merge into an end section of the channel at the outlet 5. In the embodiment shown, the first subchannel 10a is and U-shaped channel. The second subchannel 10b is surrounded by the first subchannel 10a. The channel 10 branches into the first subchannel 10a and the second subchannel 10b at a bend 11’; at another bend 11’ of the tubular heating element 11 the first subchannel 10a and the second subchannel 10b merge.

In the embodiment shown in FIG. 5, two tubular heating elements 11 are used, but in other embodiments a single tubular heating element may suffice.

In FIG. 5, parts of the tubular heating elements 11 are cut away to illustrate the interior of the tubular heating elements 11. Each tubular heating element 11 comprises a metallic sheath 11a that surrounds resistive wire 11b embedded in isolating material 11c, e.g., ceramic powder. The resistive wire 11b is arranged as a helical coil in the embodiment shown, but straight wire may be used in other embodiments. The ends of each sheath 11a may be closed by caps 11d. Terminals 11e protrude from the sheath 11a at both ends.

As shown in FIG. 5, a first tubular heating element 11 is arranged on top of a second tubular heating element 11 in the groove. Thus, a first tubular heating element 11 is adjacent to a bottom of the groove and a second tubular heating element 11 adjacent to a second housing part 2 covering the groove. The tubular heating elements 11 are held in the groove by brackets 18. The brackets 18 keep the tubular heating elements 11 at a distance from each other and at a distance from the bottom of the groove. Thus, there is a gap between the tubular heating elements 11 that allows liquid to be heated to contact the tubular heating elements along their entire circumference.

The first housing part 1 shown in FIG. 3 is fixed to the second housing part 2 and thereby the meandering groove 10 covered. FIG. 6 shows the wet side of the second housing part 2, i.e., the side facing the groove 10. FIG. 6 shows the dry side of the second housing part 2, i.e., the side facing away from the groove 10. The first housing part 1 and the second housing part 2 are connected by threaded bolts 12 shown in FIG. 2. A seal, e.g., sealing glue, is arranged between the first housing part 1 and the second housing part 2, e.g., in a sealant groove 13 of the second housing part 2.

The second housing part 2 comprises spigots connected to the channel 10 defined by the groove. Thus, the inlet 4 and outlet 5 for liquid are arranged in the second housing part 2.

The second housing part 2 comprises a plate section 14 covering the groove 10 and thereby forming a wall of the channel. The plate section 14 has an opening 15 through which ends of the tubular heating elements 11 protrude. As shown in FIG. 5, each end of each tubular heating element 11 is stuck into an opening of a metal plate 16 and therein brazed to the metal plate 16. At each of these openings, the metal plate 16 form a collar 16a that surrounds tubular heating element 11. This collar 16a is integral with the metal plate 16 and facilitates a liquid tight connection between metal plate 16 and tubular heating element 11, e.g., by brazing.

The metal plate 16 closes opening 15 of the plate section 14 of the second housing part 2. The second housing part 2 may carry a seal 17 that surrounds opening 15. The metal plate 16 may be fixed to the second housing part 2 by means bolts, by brazing, welding or an adhesive, for example.

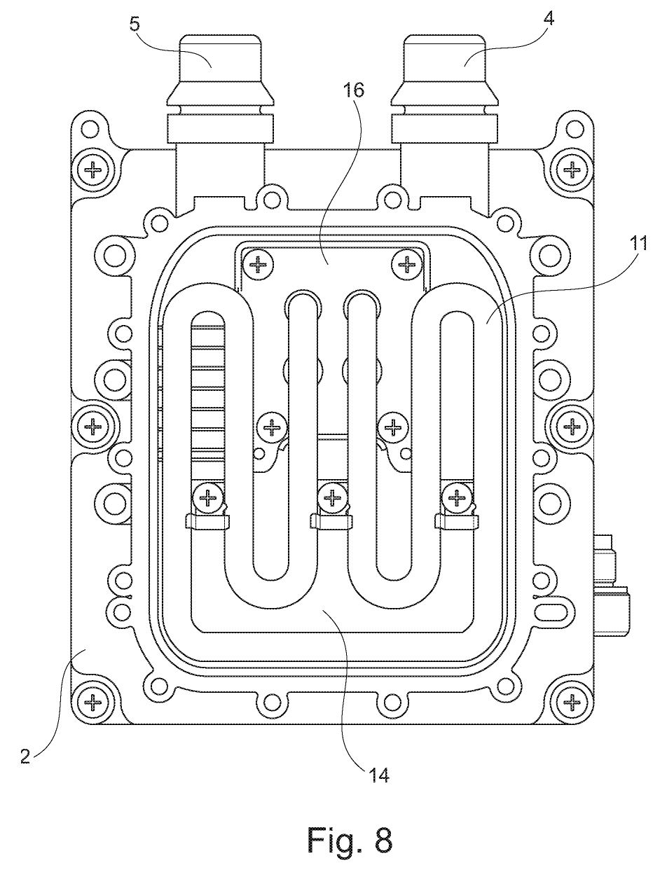

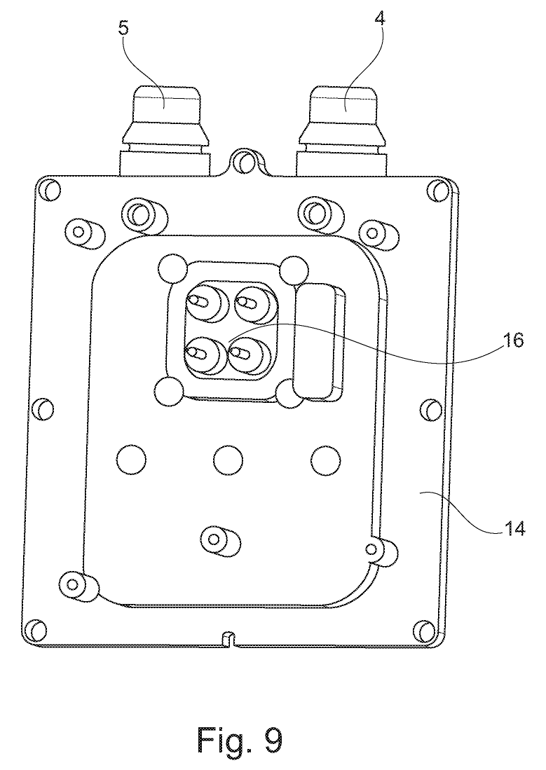

FIG. 8 shows the wet side of the second housing part 2 with the tubular heating elements 11 connected to it. FIG. 9 shows the dry side of the second housing part 2. The ends of the tubular heating elements 11 with the terminals 11d protruding from the sheath 11a as well as the metal plate 16 closing the opening 15 of the second housing part are also shown in FIG. 9.

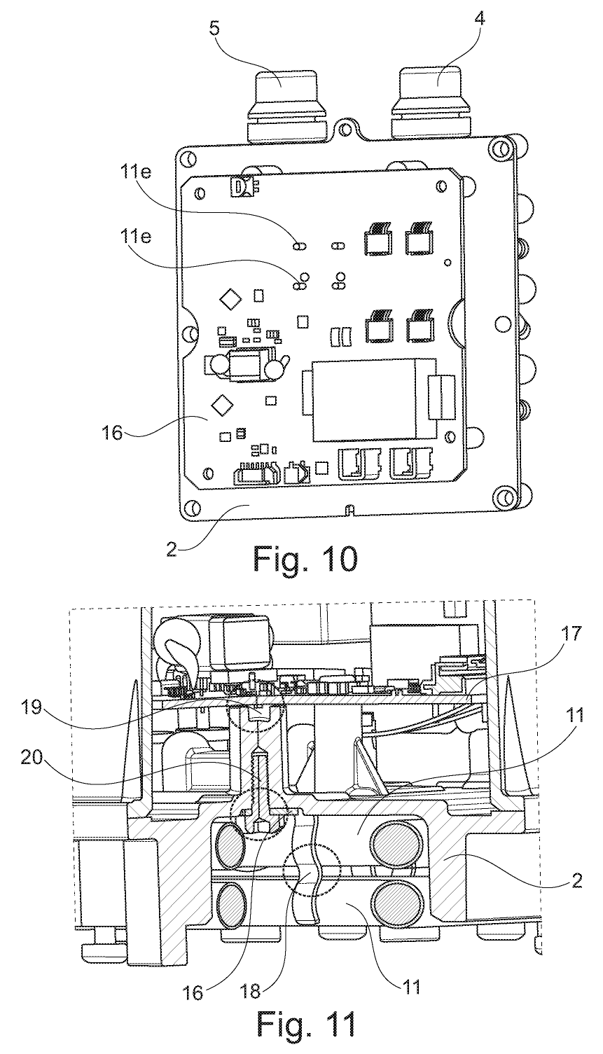

As shown in FIG. 10, a circuit board 17 with control circuitry is arranged on the dry side of the second housing part 2 and connected to the tubular heating elements 11. For example, the terminals 11e of the tubular heating element 11 may be inserted into openings of the circuit board 17 to establish an electrical connection.

FIG. 11 show schematically a detail of a cross-section of the flow heater. The control circuitry of the circuit board 17 comprises a temperature sensor 19, e.g., an NTC resistor. This sensor 19 may be arranged on a side of the circuit board 17 facing the tubular heating element 11. A thermal bridge from the tubular heating elements 11 to the temperature sensor 19 is provided by bracket 18, a bolt 20 connecting the metal plate 16 to the second housing part 2, and the second housing part 2. Thus, a problematic rise in temperature can be detected and overheating of the tubular heating elements 11 prevented.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE SIGNS

1 first housing part 20 bolt
2 second housing part
3 third housing part
4 inlet
5 outlet
6 electrical connector
7 electrical connector
9 wall
10 channel
10a first subchannel
10b second subchannel
11 tubular heating element
11a sheath
11b resistive wire
11c isolating material
11d cap
11e terminal
11’ bend
11’’ bend
12 threaded bolt
13 sealant groove
14 plate section
15 opening
16 metal plate
17 circuit board
18 bracket
19 sensor

16a collar

What is claimed is:

1. A flow heater, comprising:
a housing, wherein a channel for liquid to be heated extends from an inlet to an outlet; and
a tubular heating element arranged in the channel, said tubular heating element comprising a tubular sheath, resistive wire, and isolating material electrically isolating the resistive wire from the tubular sheath;
wherein the channel is defined by a meandering groove in a first housing part, and
the tubular heating element has a meandering shape and is arranged in the groove.

2. The flow heater according to claim 1, wherein the groove is closed by a second housing part that has an opening through which all ends of the tubular heating element protrude.

3. The flow heater according to claim 2, wherein the opening is closed by a metal plate, and wherein each end of the tubular heating element is inserted in an opening of the metal plate.

4. The flow heater according to claim 3, wherein each end of the tubular heating element is surrounded by a collar formed by the metal plate.

5. The flow heater according to claim 2, wherein a circuit board is arranged on a dry side of the second housing part and electrically connected to the tubular heating element, and wherein the circuit board is covered by a third housing part that is fixed to the second housing part.

6. The flow heater according to claim 2, wherein a plug connector for connecting the flow heater to a voltage source is arranged in the second housing part.

7. The flow heater according to claim 4, wherein the inlet and the outlet are arranged in the second housing part.

8. The flow heater according to claim 1, wherein the channel branches in an initial section into a first subchannel and a second subchannel, wherein the first subchannel and the second subchannel merge into an end section of the channel.

9. The flow heater according to claim 1, wherein a first tubular heating element and a second tubular heating element are arranged in the groove.

10. The flow heater according to claim 9, wherein the first tubular heating element is arranged adjacent to a bottom of the groove and the second tubular heating element is arranged adjacent to the second housing part.

11. The flow heater according to claim 9, wherein there is a gap in the groove between the first tubular heating element and the second tubular heating element.

12. The flow heater according to claim 9, comprising brackets that fix the first tubular heater and the second tubular heating element in the groove.

13. The flow heater according to claim 12, wherein the brackets are fixed to the second housing part and form at least part of a thermal bridge to a temperature sensor.

14. The flow heater according to claim 13, wherein each bracket is fixed to the second housing part by a bolt that forms part of the thermal bridge.

15. The flow heater according to claim 1, wherein the groove has corrugated side walls.

16. A flow heater, comprising:
a housing, wherein a channel for liquid to be heated extends from an inlet to an outlet; and
a tubular heating element arranged in the channel, said tubular heating element comprising a tubular sheath, resistive wire, and isolating material electrically isolating the resistive wire from the tubular sheath;
wherein the channel is defined by a meandering groove in a first housing part,
the tubular heating element has a meandering shape and is arranged in the groove, and
wherein the channel branches in an initial section into a first subchannel and a second subchannel, wherein the first subchannel and the second subchannel merge into an end section of the channel.
